(19) United States
(12) Patent Application Publication
(10) Pub. No.: US 2018/0366084 A1
(43) Pub. Date: Dec. 20, 2018

(54) SWITCHING BETWEEN DISPLAY TECHNOLOGIES

(71) Applicant: QUALCOMM Incorporated, San Diego, CA (US)

(72) Inventors: Amandeep Singh BEDI, Hyderabad (IN); Ashutosh GUPTA, Hyderabad (IN); Ankit BANAUDHA, Hyderabad (IN); Ashokkumar NARAYANASWAMY, Hyderabad (IN); Shankar ANAND, Hyderabad (IN)

(21) Appl. No.: 15/627,264

(22) Filed: Jun. 19, 2017

(51) Int. Cl. G09G 5/00; G09G 3/00

(52) U.S. Cl. CPC G09G 5/003; G09G 3/003; G09G 2330/023; G09G 2360/145; G09G 2360/144; G09G 2320/08; G09G 2340/0407

(57) ABSTRACT

In currently available user equipment (UE), the significantly more number of pixels in the 4K ultra high definition (UHD) display mode demands more processing power and consumes more battery charge than the 1080p high definition (HD) display mode or the standard resolution display mode. However, in low brightness, there is no perceived difference in display image quality among very high resolution (e.g., UHD), high resolution (e.g., HD) or standard resolution display modes, when viewed by the naked human eye. In an aspect of the disclosure, a method, a computer-readable medium, and an apparatus for reducing battery drain of a UE are provided. The apparatus determines a brightness level of a display screen of the UE. The apparatus also sets a resolution mode of the display screen based on the brightness level.

### BACKGROUND

### Field

The present disclosure relates generally to digital display technologies, and more particularly, to switching between display technologies.

### Background

In digital imaging, a pixel is the smallest element of a picture represented on the digital display screen. In other words, a pixel is a block of light that creates the digital display screen's smallest unit of white or color. In a digital display screen, each pixel is a sample of an original image. Therefore, more pixels generally provide a more accurate representation of the original image on a digital display screen. A pixel may be assumed as a brick in the wall that is the digital display screen. The ultra-high definition (UHD) display mode includes 4K UHD and 8K UHD, which are two digital video formats. A 4K UHD display mode or a 4K “wall” may have 3,840 pixels or bricks along the top row, compared to 1,920 pixels or bricks for one row of a 1080p high definition (HD) display mode or wall. A 4K UHD display mode may have twice as many rows compared to the 1080p HD display mode or wall. The 4K UHD display mode may have four times the number of pixels as the 1080p HD display mode. In currently available user equipment (UE), the significantly more number of pixels in the 4K UHD display mode demands more processing power and consumes more battery charge than the 1080p HD display mode or the standard resolution display mode. When the display screen is dim, the human eye may not be able to differentiate between the quality of an image displayed in the very high resolution (e.g., UHD) mode, the quality of the image displayed in the high resolution (e.g., HD) mode, and the quality of the image displayed in the standard resolution mode on the display screen of the UE. In particular, in low brightness, there is no perceived difference in display image quality among UHD, HD or standard resolution display modes, when viewed by the naked human eye.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In digital imaging, a pixel is the smallest element of a picture represented on the digital display screen. In other words, a pixel is a block or source of light that creates the digital display screen's smallest unit of white or color. In a digital display screen, each pixel may represent a sample of an original image. Therefore, more pixels may provide more accurate representation of the original image on a digital display screen. A pixel may be assumed as a brick in the wall that is the digital display screen. The UHD display mode includes 4K UHD and 8K UHD, which are two digital video formats. A 4K UHD display mode or a 4K “wall” may have 3,840 pixels or bricks along the top row, compared to 1,920 pixels or bricks for one row of a 1080p HD display mode or wall. A 4K UHD display mode may have twice as many rows compared to the 1080p HD display mode or wall. The 4K UHD display mode may have four times the number of pixels as the 1080p HD display mode. In currently available UEs, the significantly increased number of pixels in the 4K UHD display mode may demand more processing power and consume more battery charge than the 1080p HD display mode or the standard resolution display mode. When viewing a dim display, the human eye may not be able to differentiate between the quality of an image displayed in the very high resolution (e.g., UHD) mode, the quality of the image displayed in the high resolution (e.g., HD) mode, and the quality of the image displayed in the standard resolution mode on the display screen of the UE. In particular, in low brightness, there may be no perceived difference in display image quality among UHD, HD or standard resolution display mode by the naked human eye. Therefore, there is a need for a method that enables a UE to switch from UHD to HD or to standard resolution display mode, based on the current brightness level of the display/battery capacity or battery charge of the UE in order to reduce battery drain by the UE and to increase UE operating time on battery power.

In an aspect of the disclosure, a method, a computer-readable medium, and an apparatus for reducing battery drain of a UE are provided. The apparatus determines a brightness level of a display screen of the UE. The apparatus also sets a resolution mode of the display screen based on the brightness level.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1A is a diagram illustrating a display screen of a UE in a very high resolution display mode.

FIG. 1B is a diagram illustrating a display screen of a UE in a high resolution display mode.

FIG. 1C is a diagram illustrating a display screen of a UE in a standard resolution display mode.

FIG. 2A is a flowchart of a method of setting a resolution mode of the display screen of a UE based on the brightness level.

FIG. 2B is a flowchart of a method of setting a resolution mode of the display screen of the UE based on the battery level of a battery of the UE.

FIG. 2C is a flowchart of a method of setting a display mode of a UE based on the ambient light level.

FIG. 3 is a conceptual data flow diagram illustrating the data flow between different means/components in an exemplary apparatus.

FIG. 4 is a diagram illustrating an example of a hardware implementation for an apparatus employing a processing system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

In digital imaging, a pixel is the smallest element of a picture represented on the digital display screen. In other words, a pixel is a block of light that creates the digital display screen's smallest unit of white or color. In a digital display screen, each pixel is a sample of an original image. Therefore, more pixels generally provide more accurate representation of the original image in a digital display screen. A pixel may be assumed as a brick in the wall that is the digital display screen. The UHD display mode includes 4K UHD and 8K UHD, which are two digital video formats. A 4K UHD display mode or a 4K “wall” may have 3,840 pixels or bricks along the top row, compared to 1,920 pixels or bricks for one row of a 1080p HD display mode or wall. A 4K UHD display mode may have twice as many rows compared to the 1080p HD display mode or wall. The 4K UHD display mode may have four times the number of pixels as the 1080p HD display mode. In currently available mobile devices, the significantly increased number of pixels in the 4K UHD display mode demands more processing power and more battery usage than the 1080p HD display mode/the standard resolution display mode. In low brightness (of the display screen), the human eye may not be able to differentiate between the quality of an image displayed in the very high resolution (e.g., UHD) mode, the quality of the image displayed in the high resolution (e.g., HD) mode, and the quality of an image displayed in the standard resolution display mode on the display screen of the mobile device. In particular, in low brightness, there may be no perceivable difference in display image quality among UHD mode, HD mode or standard resolution display mode by the naked human eye. Therefore, there is a need for a method that enables a mobile device to switch from UHD mode to HD mode or standard resolution display mode, based on the current brightness level/battery capacity of the mobile device to reduce battery drain by the mobile device and to extend operating time of the mobile device on battery power.

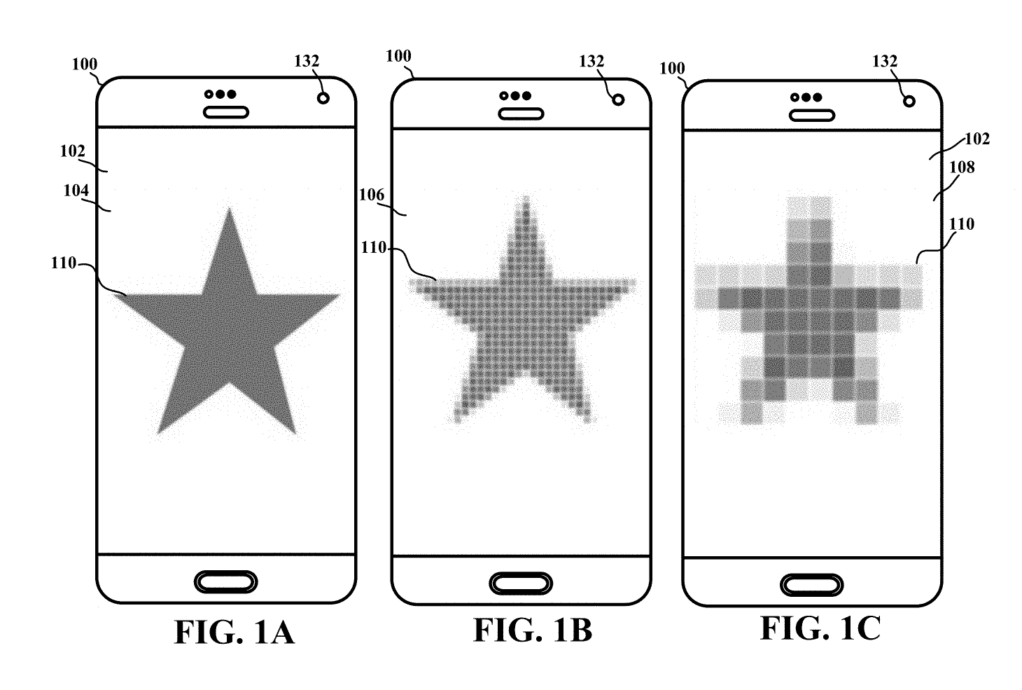

FIGS. 1A-1C are diagrams illustrating a display screen 102 of a mobile device 100 in a three different display modes. The mobile device 100 may be a UE. Examples of UEs include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a toaster, or any other similar functioning device. Some of the UEs may be referred to as Internet of things (IoT) devices (e.g., parking meter, gas pump, toaster, vehicles, etc.). The UE 100 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

In FIG. 1A, the display screen 102 of the UE 100 may display an image 110 of a star in a very high resolution (e.g., UHD) display mode 104. In FIG. 1B, the display screen 102 of the UE 100 may display the image 110 of a star in a high resolution (e.g., HD) display mode 106, which has lower resolution than the very high resolution (e.g., UHD) display mode 104. In FIG. 1C, the display screen 102 of the UE 100 may display the image 110 of a star in a standard resolution display mode 108, which has lower resolution than the high resolution (e.g., HD) display mode 106. In one configuration, the display screen 102 of the UE 100 may display an image 110 of a star in a 3-dimensional (3D) display mode 112 or in a 2-dimensional (2D) display mode 124.

As mentioned above, a pixel is the smallest element of an image represented on the digital display screen. Therefore, more pixels may provide a more accurate representation of the original image on a digital display screen. Since, in some configurations, the very high resolution (e.g., 4K UHD) display mode 104 has approximately four times the number of pixels as the high resolution (e.g., 1080p HD) display mode 106, the very high resolution (e.g., 4K UHD) display mode 104 may provide more accurate representation of the original version of the image 110 of a star, when the display screen 102 of the UE 100 is operating at a high brightness setting. However, when the display screen 102 of the UE 100 is operating at a low brightness setting, the human eye may not be able to differentiate between the quality of the image 110 displayed in the very high resolution (e.g., UHD) display mode 104 and the quality of the image 110 displayed in the high resolution (e.g., HD) display mode 106 or the standard resolution display mode 108 on the display screen 102 of the UE 100. In UE 100, the increased number of pixels in the very high resolution (e.g., 4K UHD) display mode 104 may use more processing power and consume more battery charge than the high resolution (e.g., 1080p HD) display mode 106 or the standard resolution display mode 108. Certain aspects of the disclosure may provide a solution where UE 100 may switch from the very high resolution (e.g., UHD) display mode 104 to the high resolution (e.g., HD) display mode 106 or the standard resolution display mode 108, based on the current brightness level 114 of the display screen 102 and/or the battery level 116 of the UE 100, in order to extend the operating time of UE 100.

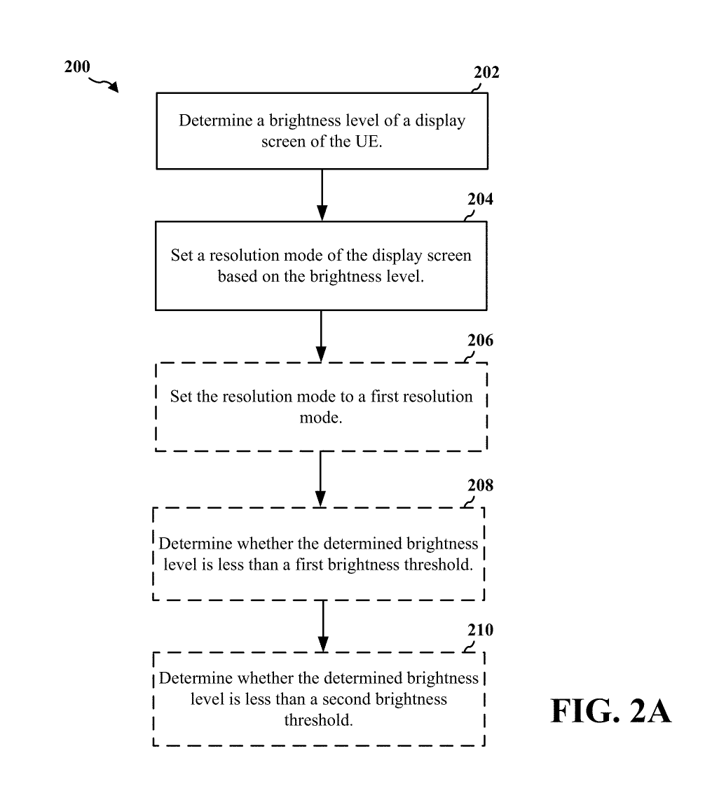

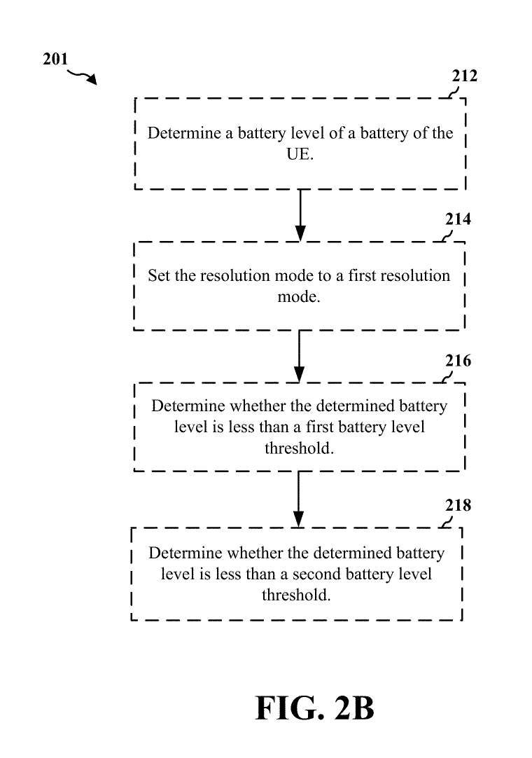

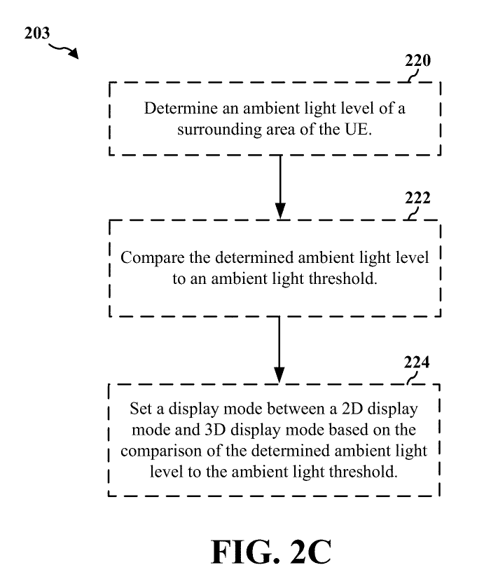

FIG. 2A is a flowchart 200 of a method of setting a resolution mode of the display screen of a UE based on the brightness level. The method may be performed by a UE (e.g., UE 100).

At 202, the UE (e.g., UE 100) may determine a brightness level (e.g., 114) of a display screen (e.g. 102) of the UE (e.g., UE 100). For example, the UE 100 may determine a brightness level 114 of the display screen 102 of the UE 100. In one configuration, the UE (e.g., UE 100) may perform the determination (at 202) of the current brightness level (e.g., 114) of the display screen (e.g., 102) at a periodic interval (e.g., every 10 seconds).

In some configurations, the UE 100 may determine the current brightness level 114 of the display screen 102 of the UE 100 by determining the amount of light being radiated by the display screen 102 of the UE 100. The more light radiated by the display screen 102 of the UE 100, the higher is the brightness level 114 of the display screen 102 of the UE 100. In another configuration, the UE 100 may determine the current brightness level 114 of the display screen 102 of the UE 100 by determining the amount of voltage/current drawn by the display screen 102 of the UE 100. In yet another configuration, the UE 100 may determine the brightness level 114 based on a display brightness control setting. The display brightness control setting may be an enumerated set of values, e.g., from 1 to n, where n is the number of brightness levels. In another configuration the display brightness control setting may be a function of ambient light level 122 as measured by an ambient light sensor 132. In such case, the display brightness control setting changes from a maximum value for low ambient light conditions to a minimum value for bright ambient light conditions.

In one configuration, the UE 100 may determine a resolution mode (e.g., 104, 106, 108) of the display screen 102 of the UE 100 by determining the pixel density currently being used by the display screen 102 of the UE 100. For example, the UE 100 may determine whether the display screen 102 of the UE 100 is operating in a very high resolution display mode 104, a high resolution display mode 106, or a standard resolution display mode 108 by determining the pixel density currently being used by the display screen 102 of the UE 100. For example, a 4K UHD display mode or a 4K “wall” may have 3,840 pixels or bricks along the top row, compared to 1,920 pixels or bricks for one row of a 1080p HD display mode or wall. A 4K UHD display mode may have twice as many rows compared to the 1080p HD display mode or wall. The 4K UHD display mode may have four times the number of pixels as the 1080p HD display mode. Therefore, by determining the pixel density currently being used by the display screen 102 of the UE 100, the UE 100 may determine whether the display screen 102 of the UE 100 is operating in a very high resolution display mode 104, a high resolution display mode 106, or a standard resolution display mode 108.

At 204, the UE (e.g., UE 100) may set a resolution mode of the display screen based on the brightness level. For example, the UE 100 may set a resolution mode (e.g., 104, 106, 108) of the display screen 102 of the UE 100 based on the brightness level 114 of the display screen 102 of the UE 100.

Optionally, at 206, the UE (e.g., UE 100) may set the resolution mode (104, 106, 108) to a first resolution mode (e.g., very high resolution display mode 104). For example, the UE 100 may set the resolution mode (e.g., 104, 106, 108) of the display screen 102 of the UE 100 to a first resolution mode (e.g., very high resolution display mode 104) based on the determined brightness level 114 of the display screen 102 of the UE 100. In an aspect, the resolution mode of the display screen 102 of the UE 100 is set to the first resolution mode (e.g., very high resolution display mode 104) when the brightness level 114 of the display screen 102 of the UE 100 is determined to be greater than or equal to a first brightness threshold 118. The first brightness threshold 118 may be 50% of the full brightness level 114.

Optionally, at 208, the UE (e.g., UE 100) may determine whether the determined brightness level (e.g., 114) is less than the first brightness threshold (e.g., 118). The first brightness threshold 118 may be 50% of the full brightness level 114.

Optionally, at 210, the UE (e.g., UE 100) may determine whether the determined brightness level (e.g., 114) is less than a second brightness threshold (e.g., 120). In one configuration, the second brightness threshold 120 may be less than the first brightness threshold 118.

In an aspect, when the display screen 102 is in a first resolution mode (e.g., very high resolution display mode 104), the UE 100 may set the display screen 102 to a second resolution mode (e.g., high resolution display mode 106) when the brightness level 114 is determined to be less than the first brightness threshold 118 and greater than or equal to a second brightness threshold 120. The first brightness threshold 118 may be 50% of the full brightness level 114 and the second brightness threshold may be 30% of the full brightness level 114. For example, when the display screen 102 of the UE 100 is in the very high resolution display mode 104 (UHD), the UE 100 may set the display screen 102 to the high resolution display mode 106 (HD) when the brightness level 114 is determined to be less than the first brightness threshold 118 (e.g., 50% of the full brightness level 114) and greater than or equal to a second brightness threshold 120 (e.g., 30% of the full brightness level 114).

In another aspect, when the display screen 102 is in a first resolution mode (e.g., very high resolution display mode 104) or in a second resolution mode (e.g., high resolution display mode 106), the UE 100 may set the display screen 102 to a third resolution mode (e.g., a standard resolution display mode 108) when the brightness level 114 is determined to be less than the second brightness threshold 120. For example, when the display screen 102 of the UE 100 is in the very high resolution display mode 104 (UHD) or the high resolution display mode 106 (HD), the UE 100 may set the display screen 102 to the standard resolution display mode 108, when the brightness level 114 is determined to be less than the second brightness threshold 120 (e.g., 30% of the full brightness level 114).

In one configuration, the first resolution mode 104 has a higher resolution than the second resolution mode 106. For example, the very high resolution display mode 104 (UHD) has a higher resolution than the high resolution display mode 106 (HD). In another configuration, the second resolution mode 106 has a higher resolution than the third resolution mode 108. For example, the high resolution display mode 106 (HD) has a higher resolution the standard resolution display mode 108.

In another configuration, if the determined brightness level (e.g., 114) at 210 is not less than the second brightness threshold 120, the process 200 may return to 202 after a certain amount of delay, e.g., a few seconds of delay. A delay may be needed to avoid ping ponging between the two display modes (e.g., the high resolution display mode 106 (HD) and the standard resolution display mode 108). If the condition is satisfied for the delay time then switching between the display modes may be triggered.

FIG. 2B is a flowchart 201 of a method of setting a resolution mode of the display screen of the UE based on the battery level of a battery of the UE. The method may be performed by an UE (e.g., UE 100). The blocks of the flowchart 201 may be optionally performed after 202 of flowchart 200 of FIG. 2A.

Optionally, at 212, the UE (e.g., UE 100) may determine a battery level (e.g., 116) of a battery of the UE (e.g., UE 100). For example, the UE 100 may determine a battery level 116 of a battery embedded in the UE 100. In one configuration, the UE (e.g., UE 100) may perform the determination (at 212) of the current battery level (e.g., 116) of the battery embedded in the UE 100 at a periodic interval (e.g., every 10 seconds).

In one configuration, the battery of the UE 100 may have a battery fuel gauge IC which may continuously/periodically track the charge state of the battery of the UE 100. The battery fuel gauge IC may use an algorithm for the type of battery chemistry, e.g., for lithium ion battery chemistry (e.g., coulomb counter) to track the charge state of the battery of the UE 100. The battery fuel gauge may also have a current shunt with an amplifier and may measure the consumed current, sum the consumed current over time and compare it to the programmed battery capacity. The consumed current may be correlated to battery capacity such that the consumed current may be used to determine remaining battery charge/capacity. In another configuration, the battery fuel gauge may measure the impedance of the battery of the UE 100. A lithium ion battery cell has a specific impedance for each state of charge. Therefore, an estimate may be made regarding the amount of charge left in the battery of the UE 100 by measuring the impedance of the battery. In another configuration, the UE 100 may measure the voltage of the battery and determine remaining battery charge.

In one configuration, the UE (e.g., UE 100) may determine a resolution mode (e.g., 104, 106, 108) of the display screen (e.g. 102) of the mobile device (e.g., 100) by determining the pixel density setting currently being used by display screen (e.g. 102) of the mobile device (e.g., 100). For example, the UE 100 may determine whether the display screen 102 of the UE 100 is operating in a very high resolution display mode 104, a high resolution display mode 106, or a standard resolution display mode 108 by determining the pixel density setting currently being used by the display screen (e.g. 102) of the mobile device (e.g., 100).

In an aspect, the UE 100 may set a resolution mode (e.g., 104, 106, 108) of the display screen 102 of the UE 100 based on the battery level 116 of the battery of the UE 100.

Optionally, at 214, the UE (e.g., UE 100) may set the resolution mode (104, 106, 108) to a first resolution mode (e.g., very high resolution display mode 104). For example, the UE 100 may set the resolution mode (e.g., 104, 106, 108) of the display screen 102 of the UE 100 to a first resolution mode (e.g., very high resolution display mode 104) based on the determined battery level 116 of the UE 100. In an aspect, the resolution mode of the display screen 102 of the UE 100 is set to the first resolution mode (e.g., very high resolution display mode 104) when the battery level 116 of the UE 100 is determined to be greater than or equal to a first battery level threshold 128. The first battery level threshold 128 may be 50% of the full battery level 116.

Optionally, at 216, the UE (e.g., UE 100) may determine whether the determined battery level (e.g., 116) is less than the first battery level threshold (e.g., 128). The first battery level threshold 128 may be 50% of the full battery level 116.

Optionally, at 218, the UE (e.g., UE 100) may determine whether the determined battery level (e.g., 116) is less than a second battery level threshold (e.g., 130). In one configuration, the second battery level threshold 130 may be less than the first battery level threshold 128.

In an aspect, when the display screen 102 is in a first resolution mode (e.g., very high resolution display mode 104), the UE 100 may set the display screen 102 to a second resolution mode (e.g., high resolution display mode 106) when the battery level 116 is determined to be less than the first battery level threshold 128 and greater than or equal to a second battery level threshold 130. The first battery level threshold 128 may be 50% of the full battery level 116 and the second battery level threshold may be 25% of the full battery level 116. For example, when the display screen 102 of the UE 100 is in the very high resolution display mode 104 (UHD), the UE 100 may set the display screen 102 to the high resolution display mode 106 (HD) when the battery level 116 is determined to be less than the first battery level threshold 128 (e.g., 50% of the full battery level 116) and greater than or equal to a second battery level threshold 130 (e.g., 25% of the full battery level 116).

In another aspect, when the display screen 102 is in a first resolution mode (e.g., very high resolution display mode 104) or in a second resolution mode (e.g., high resolution display mode 106), the UE 100 may set the display screen 102 to a third resolution mode (e.g., a standard resolution display mode 108) when the battery level 116 is determined to be less than the second battery level threshold 130. For example, when the display screen 102 of the UE 100 is in the very high resolution display mode 104 (UHD) or the high resolution display mode 106 (HD), the UE 100 may set the display screen 102 to the standard resolution display mode 108, when the battery level 116 is determined to be less than the second battery level threshold 130 (e.g., 25% of the full battery level 116).

If the determined battery level 116 at 218 is not less than the second battery level threshold 130, the process 201 may return to 212 after a certain amount of delay, e.g., a few seconds of delay. A delay may be needed to avoid ping ponging between the two display modes (e.g., the high resolution display mode 106 (HD) and the standard resolution display mode 108). If the condition is satisfied for the delay time then switching between the display modes may be triggered. In an aspect, the delay time for brightness level and the delay time for battery level may be independent of each other.

FIG. 2C is a flowchart 203 of a method of setting a display mode of a UE between a 2D display mode and a 3D display mode based on the ambient light level. The method may be performed by an UE (e.g., UE 100). The blocks of the flowchart 203 may be optionally performed after 202 of flowchart 200 of FIG. 2A.

Optionally, at 220, the UE may determine an ambient light level of the surrounding area of the UE (e.g., UE 100). For example, the UE 100 may determine an ambient light level 122 of the surrounding area of the UE 100 using an ambient light sensor 132 embedded on the UE 100 (FIGS. 1A-1C).

Optionally, at 222, the UE may compare the determined ambient light level to an ambient light threshold. For example, the UE 100 may compare the determined ambient light level 122 to an ambient light threshold 126.

Optionally, at 224, the UE may set the display mode of the display screen between a 2D display mode and a 3D display mode based on the comparison of the determined ambient light level to the ambient light threshold. For example, the UE 100 may set the display mode (e.g., 104, 106, 108) of the display screen 102 between a 2D display mode 124 and a 3D display mode 112 based on the comparison of the determined ambient light level 122 to the ambient light threshold 126.

In an aspect, when the display screen 102 of the UE 100 is in a 3D display mode 112, the UE 100 may set the display screen 102 to a 2D display mode 124, when the ambient light level 122 is determined to be below ambient light threshold 126. In another aspect, when the display screen 102 of the UE 100 is in a 2D display mode 124, the UE 100 may set the display screen 102 to a 3D display mode 112, when the ambient light level 122 is determined to be above the ambient light threshold 126.

In yet another aspect, the UE 100 may determine whether the display screen 102 is in 2D display mode 124 or 3D display mode 112 by checking the presence of 3^{rd} dimension (e.g., depth) in the still/video image displayed on the display screen 102 of the UE 100. If a 3^{rd} dimension (e.g., depth) is present in the still/video image displayed on the display screen 102 of the UE 100, then the display screen 102 is operating in a 3D display mode 112. Otherwise, the display screen 102 is operating in a 2D display mode 124.

In one configuration, the first brightness threshold 118, the second brightness threshold 120, the first battery level threshold 128, the second battery level threshold 130, and the ambient light threshold 126 are determined based on a display technology (e.g., LCE, LED, or the like) used in the display screen 102 of the UE 100. In some other configuration, the first brightness threshold 118, the second brightness threshold 120, the first battery level threshold 128, the second battery level threshold 130, and the ambient light threshold 126 may be preconfigured based on the display technology (e.g., LCD, LED, or the like) used in the display screen 102 of the UE 100.

In one or more configurations of this disclosure, the different steps of methods 200, 201, and 203 of FIGS. 2A, 2B, and 2C, may be performed independently, in tandem or may be combined to be performed in arbitrary order to change the resolution mode or the display mode (e.g., 104, 106, 108, 124, 112) of the display screen (e.g., 102) of the UE (e.g., UE 100).

In an aspect, a number of resolution modes (e.g., 104, 106, 112, 124) supported by the UE 100 may be mapped to different pre-selected battery levels 116 and number of brightness levels 114 supported by the UE 100. The mapped resolution mode (e.g., 104, 106, 112, 124) may be the highest (or maximum) resolution mode (e.g., 104, 106, 112, 124) supported at that battery level 116 or at that brightness level 114. The selected resolution mode (e.g., 104, 106, 112, 124) for the display 102 may be the lowest (or the highest) resolution mode (e.g., 104, 106, 112, 124) among the resolution modes (e.g., 104, 106, 112, 124) selected independently based on the battery level 116 and the brightness levels 114. That is, the selected resolution mode (e.g., 104, 106, 112, 124) will be the minimum of the maximum resolution mode for the current brightness level 114 of the display 102 and the maximum resolution mode for the current battery level 116.

For example, the resolution modes may be 3D (112) UHD (104), 3D (112) HD (106), 2D (124) UHD (104), or 2D (124) HD (106). The different battery levels 116 may be 70% of the full battery level 116, 50%-70% of the full battery level 116, 30%-50% of the full battery level 116, and less than 30% of the full battery level 116. The different brightness levels 114 (e.g., N1, N2, N3) may be the brightness level 114 (e.g., N1) being greater than or equal to the first brightness threshold 118 (e.g., 50% of the full brightness level 114), the brightness level 114 (e.g., N2) being less than the first brightness threshold 118 (e.g., 50% of the full brightness level 114) and greater than or equal to the second brightness threshold 120 (e.g., 30% of the full brightness level 114), and the brightness level 114 (e.g., N3) being less than the second brightness threshold 120 (e.g., 30% of the full brightness level 114). In other configurations, the number of brightness levels 114 (e.g., N1, N2, N3), number of battery levels 116, number of resolution modes (e.g., 104, 106, 112, 124) may be more or less than illustrated by the above example.

In one configuration, for a fixed brightness level 114, for example, when the brightness level 114 is greater than or equal to the first brightness threshold 118 (e.g., 50% of the full brightness level 114), and when the display screen 102 of the UE 100 is in a 3D display mode 112, the UE 100 may set the display screen 102 to a 2D display mode 124, when the battery level 116 is determined to be below the first battery level threshold 128 (e.g., 50% of the full battery level 116).

In an aspect, for a fixed brightness level 114, for example, the brightness level 114 being greater than or equal to the first brightness threshold 118 (e.g., 50% of the full brightness level 114), when the battery level 116 is above 70% of the full battery level 116, the display screen 102 of the UE 100 may display the image 110 of a star on the display screen 102 of the UE 100 in a 3D (e.g., 112) UHD (e.g., 104) display mode. In another aspect, when the battery level 116 is between 50% to 70% of the full battery level 116, the display screen 102 of the UE 100 may display the image 110 of a star on the display screen 102 of the UE 100 in a 3D (e.g., 112) HD (e.g., 106) display mode. In yet another aspect, when the battery level 116 is between 30% to 50% of the full battery level 116, the display screen 102 of the UE 100 may display the image 110 of a star on the display screen 102 of the UE 100 in a 2D (e.g., 124) UHD (e.g., 104) display mode. In another aspect, when the battery level 116 is less than 30% of the full battery level 116, the display screen 102 of the UE 100 may display the image 110 of a star on the display screen 102 of the UE 100 in a 2D (e.g., 124) HD (e.g., 106) display mode.

In yet another aspect, for a fixed brightness level 114, for example, when the brightness level 114 is less than the first brightness threshold 118 (e.g., 50% of the full brightness level 114) and greater than or equal to the second brightness threshold (e.g., 30% of the full brightness level 114), and when the display screen 102 of the UE 100 is in a 2D display mode 112, the display screen 102 of the UE 100 may display the image 110 of a star on the display screen 102 of the UE 100 in a 2D (e.g., 124) UHD (e.g., 104) display mode, when the battery level 116 is greater than 30% of the full battery level 116. In another aspect, when the battery level 116 is less than 30% of the full battery level 116, the display screen 102 of the UE 100 may display the image 110 of a star on the display screen 102 of the UE 100 in a 2D (e.g., 124) HD (e.g., 106) display mode.

In yet another aspect, for a fixed brightness level 114, for example, when the brightness level 114 is less than the second brightness threshold (e.g., 30% of the full brightness level 114), and when the display screen 102 of the UE 100 is in a 2D display mode 112, the display screen 102 of the UE 100 may display the image 110 of a star on the display screen 102 of the UE 100 in a 2D (e.g., 124) HD (e.g., 106) display mode for all battery levels 116.

Therefore, in the above mentioned configurations, if the maximum resolution mode based on the current brightness level 114 of the display screen 102 of the UE 100 is x and the maximum resolution mode based on the current battery level 116 of the UE 100 is y, the minimum of x and y is the selected resolution mode. For example, if the maximum resolution mode based on the current brightness level 114 of the display screen 102 of the UE 100 is 3D (112) UHD (104) mode, and the maximum resolution mode based on the current battery level 116 of the UE 100 is 2D (e.g., 124) HD (e.g., 106) mode, the selected resolution mode will be the minimum of 3D (112) UHD (104) mode and 2D (e.g., 124) HD (e.g., 106) mode, which is 2D (e.g., 124) HD (e.g., 106) mode.

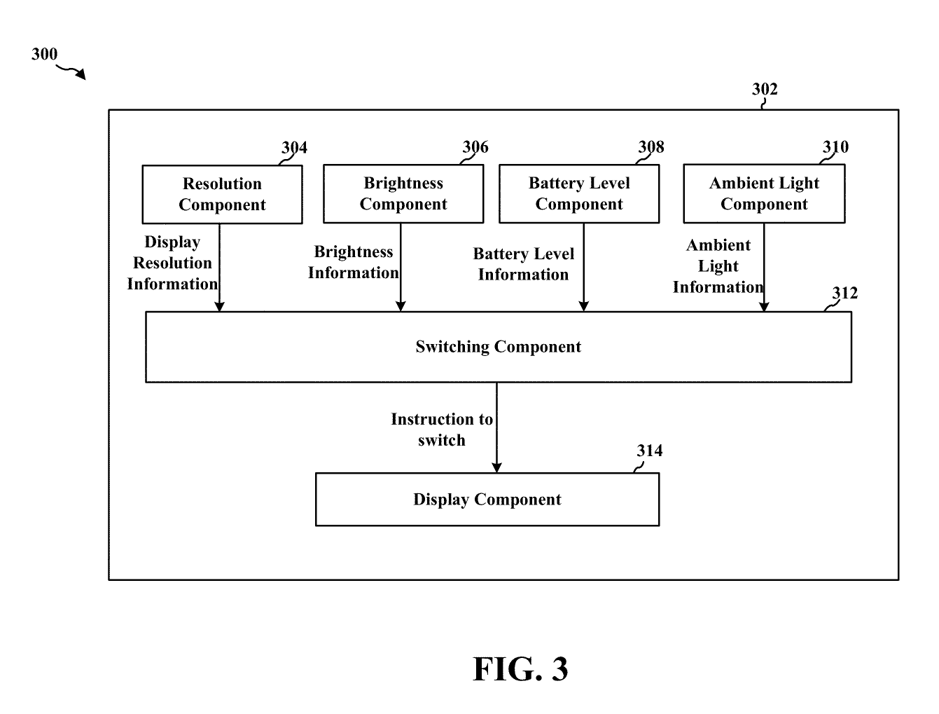

FIG. 3 is a conceptual data flow diagram 300 illustrating the data flow between different means/components in an exemplary apparatus 302. The apparatus 302 may be a UE (e.g., UE 100).

The apparatus 302 includes a resolution component 304 that may determine the resolution or the display mode (e.g., 104, 106, 108, 124, 112) of the display screen (e.g., 102) of the apparatus 302. The apparatus 302 also includes a brightness component 306 that may determine the current brightness level (e.g., 114) of the display screen (e.g., 102) of the apparatus 302. Further, the apparatus 302 includes a battery level component 308 that may determine the current battery level (e.g., 116) of a battery of the apparatus 302. Moreover, the apparatus 302 includes an ambient light component 310 that may determine the ambient light level 122 of the surrounding area of the apparatus 302.

Additionally, the apparatus 302 includes a switching component 312 that may set the display screen (e.g., 102) from a first resolution mode (e.g., 104) to a second resolution mode (e.g., 106), when the brightness level (e.g., 114) and/or the battery level (e.g., 116) is less than a respective first threshold (e.g., 118/128) and greater than or equal to a respective second threshold (e.g., 120/130). The switching component 312 may also set the display screen (e.g., 102) from the second resolution mode (e.g., 106) to a third resolution mode (e.g., 108) when the brightness level (e.g., 114) and/or the battery level (e.g., 116) is less than the respective second threshold (e.g., 120/130). Further, the switching component 312 may set the display screen (e.g., 102) from the second resolution mode (e.g., 106) to a first resolution mode (e.g., 104) when the brightness level (e.g., 114) and/or the battery level (e.g., 116) is greater than or equal to the respective first threshold (e.g., 118/128). Moreover, the switching component 312 may set the display screen (e.g., 102) from the third resolution mode (e.g., 108) to the second resolution mode (e.g., 106) when the brightness level (e.g., 114) and/or the battery level (e.g., 116) is greater than or equal to the respective second threshold (e.g., 120/130) and less than the respective first threshold (e.g., 118, 128). Additionally, the switching component 312 may set the display screen (e.g., 102) from the third resolution mode (e.g., 108) to the first resolution mode (e.g., 104) if the brightness level (e.g., 114) or the battery capacity (e.g., 116) is greater than or equal to the first threshold (e.g., 118/128). Furthermore, the switching component 312 may set the display screen (e.g., 102) from a 3D display mode (e.g., 112) to a 2D display mode (e.g., 124) when the ambient light level (e.g., 122) is below an ambient light threshold (e.g., 126). The switching component 312 may also set the display screen (e.g., 102) from the 2D display mode (e.g., 124) to the 3D display mode (e.g., 112) when the ambient light level (e.g., 122) is above the ambient light threshold (e.g., 126).

The apparatus 302 also includes a display component 314 that may display still or video images on a display screen (e.g., 102) in a display mode based on an instruction from the switching component 312.

The apparatus may include additional components that perform each of the blocks of the algorithm in the aforementioned flowcharts of FIGS. 2A-2C. As such, each block in the aforementioned flowcharts of FIGS. 2A-2C may be performed by a component and the apparatus may include one or more of the components. The components may be one or more hardware components specifically configured to carry out the stated processes/algorithm, implemented by a processor configured to perform the stated processes/algorithm, stored within a computer-readable medium for implementation by a processor, or some combination thereof.

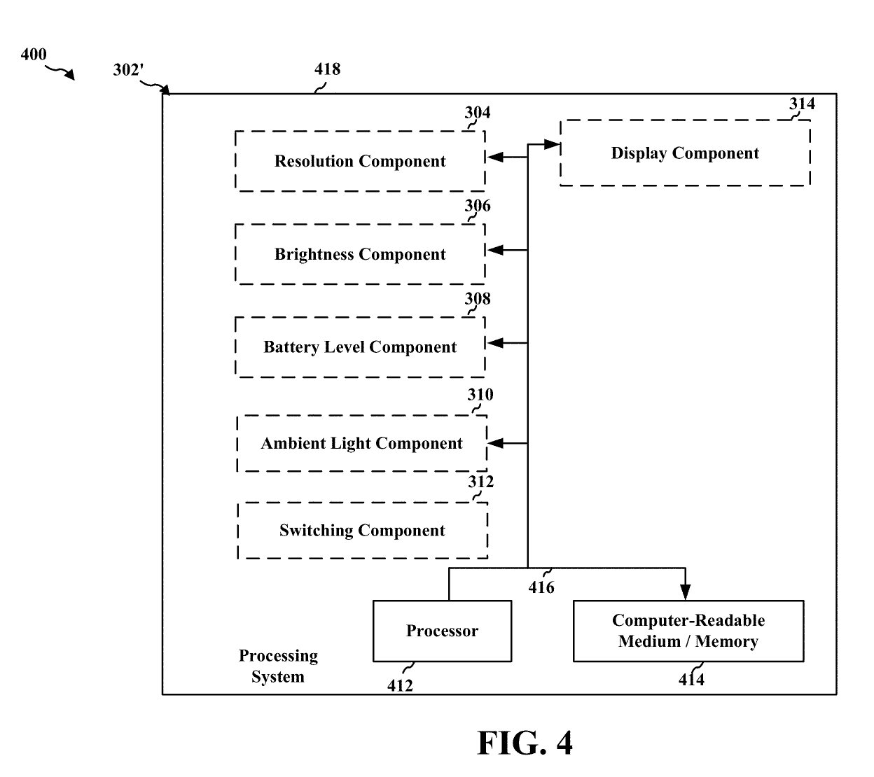

FIG. 4 is a diagram 400 illustrating an example of a hardware implementation for an apparatus 302′ employing a processing system 418.

The processing system 418 may be implemented with a bus architecture, represented generally by the bus 416. The bus 416 may include any number of interconnecting buses and bridges depending on the specific application of the processing system 418 and the overall design constraints. The bus 416 links together various circuits including one or more processors and/or hardware components, represented by the processor 412, the resolution component 304, the brightness component 306, the battery level component 308, the ambient light component 310, the switching component 312, the display component 314, and the computer-readable medium/memory 414. The bus 416 may also link various other circuits such as timing sources, peripherals, voltage regulators, and power management circuits, which are well known in the art, and therefore, will not be described any further.

The processor 412 is responsible for general processing, including the execution of software stored on the computer-readable medium/memory 414. The software, when executed by the processor 412, causes the processing system 418 to perform the various functions described supra for any particular apparatus. The computer-readable medium/memory 414 may also be used for storing data that is manipulated by the processor 412 when executing software. The processing system 418 further includes at least one of the resolution component 304, the brightness component 306, the battery level component 308, the ambient light component 310, the switching component 312, and the display component 314. The components may be software components running in the processor 412, resident/stored in the computer readable medium/memory 414, one or more hardware components coupled to the processor 412, or some combination thereof.

In one configuration, the UE 302/302′ includes means for determining a brightness level of a display screen of the UE, and means for setting a resolution mode of the display screen based on the brightness level.

In an aspect, the means for setting is further configured to set the resolution mode to a first resolution mode, and the means for determining is further configured to determine whether the determined brightness level is less than a first brightness threshold. In another aspect, the resolution mode is set to a second resolution mode when the brightness level is determined to be less than the first brightness threshold, the second resolution mode being lower than the first resolution mode.

In one configuration, the means for determining is further configured to determine whether the determined brightness level is less than a second brightness threshold. In an aspect, the second brightness threshold is less than the first brightness threshold. In another aspect, the resolution mode is set to the second resolution mode when the brightness level is determined to be less than the first brightness threshold and greater than or equal to the second brightness threshold. In yet another aspect, the resolution mode is set to a third resolution mode when the brightness level is determined to be less than the second brightness threshold. In one configuration, the third resolution mode is lower than the second resolution mode.

In another configuration, the resolution mode is set to the first resolution mode when the brightness level is determined to be greater than or equal to the first brightness threshold.

In an aspect, the means for determining is further configured to determine a battery level of a battery of the UE. In another aspect, the resolution mode of the display screen is further set based on the battery level.

In one configuration, the means for setting is further configured to set the resolution mode to a first resolution mode, and the means for determining is further configured to determine whether the determined battery level is less than a first battery level threshold. In another configuration, the resolution mode is set to a second resolution mode when the battery level is determined to be less than the first battery level threshold. In yet another configuration, the second resolution mode is lower than the first resolution mode.

In an aspect, the means for determining is further configured to determine whether the determined battery level is less than a second battery level threshold. In another aspect, the second battery level threshold is less than the first battery level threshold. In yet another aspect, the resolution mode is set to the second resolution mode when the battery level is determined to be less than the first battery level threshold and greater than or equal to the second battery level threshold. In yet another aspect, the resolution mode is set to a third resolution mode when the battery level is determined to be less than the second battery level threshold. In one configuration, the third resolution mode is lower than the second resolution mode.

In another configuration, the resolution mode is set to the first resolution mode when the battery level is determined to be greater than or equal to the first battery level threshold.

In an aspect, the means for determining is further configured to determine an ambient light level of a surrounding area of the UE. In another aspect, the UE 302/302′ further includes means for comparing the determined ambient light level to an ambient light threshold. In yet another aspect, the means for setting is further configured to set a display mode between a 2D display mode and a 3D display mode based on the comparison of the determined ambient light level to the ambient light threshold.

The aforementioned means may be one or more of the aforementioned components of the apparatus 302 and/or the processing system 418 of the apparatus 302′ configured to perform the functions recited by the aforementioned means.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method of reducing battery drain of a user equipment (UE), comprising:
determining a brightness level of a display screen of the UE; and
setting a resolution mode of the display screen based on the brightness level.

2. The method of claim 1, further comprising:
setting the resolution mode to a first resolution mode; and
determining whether the determined brightness level is less than a first brightness threshold,
wherein the resolution mode is set to a second resolution mode when the brightness level is determined to be less than the first brightness threshold, the second resolution mode being lower than the first resolution mode.

3. The method of claim 2, further comprising determining whether the determined brightness level is less than a second brightness threshold, the second brightness threshold being less than the first brightness threshold, wherein the resolution mode is set to the second resolution mode when the brightness level is determined to be less than the first brightness threshold and greater than or equal to the second brightness threshold, and the resolution mode is set to a third resolution mode when the brightness level is determined to be less than the second brightness threshold, the third resolution mode being lower than the second resolution mode.

4. The method of claim 3, wherein the resolution mode is set to the first resolution mode when the brightness level is determined to be greater than or equal to the first brightness threshold.

5. The method of claim 1, further comprising determining a battery level of a battery of the UE, wherein the resolution mode of the display screen is further set based on the battery level.

6. The method of claim 5, further comprising:
setting the resolution mode to a first resolution mode; and
determining whether the determined battery level is less than a first battery level threshold,
wherein the resolution mode is set to a second resolution mode when the battery level is determined to be less than the first battery level threshold, the second resolution mode being lower than the first resolution mode.

7. The method of claim 6, further comprising determining whether the determined battery level is less than a second battery level threshold, the second battery level threshold being less than the first battery level threshold, wherein the resolution mode is set to the second resolution mode when the battery level is determined to be less than the first battery level threshold and greater than or equal to the second battery level threshold, and the resolution mode is set to a third resolution mode when the battery level is determined to be less than the second battery level threshold, the third resolution mode being lower than the second resolution mode.

8. The method of claim 7, wherein the resolution mode is set to the first resolution mode when the battery level is determined to be greater than or equal to the first battery level threshold.

9. The method of claim 1, further comprising:
determining an ambient light level of a surrounding area of the UE;
comparing the determined ambient light level to an ambient light threshold; and
setting a display mode between a 2-dimensional (2D) display mode and a 3-dimensional (3D) display mode based on the comparison of the determined ambient light level to the ambient light threshold.

10. A user equipment (UE) comprising:
means for determining a brightness level of a display screen of the UE; and
means for setting a resolution mode of the display screen based on the brightness level.

11. The UE of claim 10, wherein:
the means for setting is further configured to set the resolution mode to a first resolution mode; and
the means for determining is further configured to determine whether the determined brightness level is less than a first brightness threshold,
wherein the resolution mode is set to a second resolution mode when the brightness level is determined to be less than the first brightness threshold, the second resolution mode being lower than the first resolution mode.

12. The UE of claim 11, wherein the means for determining is further configured to determine whether the determined brightness level is less than a second brightness threshold, the second brightness threshold being less than the first brightness threshold, wherein the resolution mode is set to the second resolution mode when the brightness level is determined to be less than the first brightness threshold and greater than or equal to the second brightness threshold, and the resolution mode is set to a third resolution mode when the brightness level is determined to be less than the second brightness threshold, the third resolution mode being lower than the second resolution mode.

13. The UE of claim 12, wherein the resolution mode is set to the first resolution mode when the brightness level is determined to be greater than or equal to the first brightness threshold.

14. The UE of claim 10, wherein the means for determining is further configured to determine a battery level of a battery of the UE, wherein the resolution mode of the display screen is further set based on the battery level.

15. The UE of claim 14, wherein:
the means for setting is further configured to set the resolution mode to a first resolution mode; and
the means for determining is further configured to determine whether the determined battery level is less than a first battery level threshold,
wherein the resolution mode is set to a second resolution mode when the battery level is determined to be less than the first battery level threshold, the second resolution mode being lower than the first resolution mode.

16. The UE of claim 15, wherein the means for determining is further configured to determine whether the determined battery level is less than a second battery level threshold, the second battery level threshold being less than the first battery level threshold, wherein the resolution mode is set to the second resolution mode when the battery level is determined to be less than the first battery level threshold and greater than or equal to the second battery level threshold, and the resolution mode is set to a third resolution mode when the battery level is determined to be less than the second battery level threshold, the third resolution mode being lower than the second resolution mode.

17. The UE of claim 16, wherein the resolution mode is set to the first resolution mode when the battery level is determined to be greater than or equal to the first battery level threshold.

18. The UE of claim 10, wherein:
the means for determining is further configured to determine an ambient light level of a surrounding area of the UE;
means for comparing the determined ambient light level to an ambient light threshold; and
the means for setting is further configured to set a display mode between a 2-dimensional (2D) display mode and a 3-dimensional (3D) display mode based on the comparison of the determined ambient light level to the ambient light threshold.

19. A user equipment (UE) comprising:
a memory; and
at least one processor coupled to the memory and configured to:
determine a brightness level of a display screen of the UE; and
set a resolution mode of the display screen based on the brightness level.

20. The UE of claim 19, wherein the at least one processor is further configured to:
set the resolution mode to a first resolution mode; and
determine whether the determined brightness level is less than a first brightness threshold,
wherein the resolution mode is set to a second resolution mode when the brightness level is determined to be less than the first brightness threshold, the second resolution mode being lower than the first resolution mode.

21. The UE of claim 20, wherein the at least one processor is further configured to determine whether the determined brightness level is less than a second brightness threshold, the second brightness threshold being less than the first brightness threshold, wherein the resolution mode is set to the second resolution mode when the brightness level is determined to be less than the first brightness threshold and greater than or equal to the second brightness threshold, and the resolution mode is set to a third resolution mode when the brightness level is determined to be less than the second brightness threshold, the third resolution mode being lower than the second resolution mode.

22. The UE of claim 21, wherein the resolution mode is set to the first resolution mode when the brightness level is determined to be greater than or equal to the first brightness threshold.

23. The UE of claim 19, wherein the at least one processor is further configured to determine a battery level of a battery of the UE, wherein the resolution mode of the display screen is further set based on the battery level.

24. The UE of claim 23, wherein the at least one processor is further configured to:
set the resolution mode to a first resolution mode; and
determine whether the determined battery level is less than a first battery level threshold,
wherein the resolution mode is set to a second resolution mode when the battery level is determined to be less than the first battery level threshold, the second resolution mode being lower than the first resolution mode.

25. The UE of claim 24, wherein the at least one processor is further configured to determine whether the determined battery level is less than a second battery level threshold, the second battery level threshold being less than the first battery level threshold, wherein the resolution mode is set to the second resolution mode when the battery level is determined to be less than the first battery level threshold and greater than or equal to the second battery level threshold, and the resolution mode is set to a third resolution mode when the battery level is determined to be less than the second battery level threshold, the third resolution mode being lower than the second resolution mode.

26. The UE of claim 25, wherein the resolution mode is set to the first resolution mode when the battery level is determined to be greater than or equal to the first battery level threshold.

27. The UE of claim 19, wherein the at least one processor is further configured to:
determine an ambient light level of a surrounding area of the UE;
compare the determined ambient light level to an ambient light threshold; and
set a display mode between a 2-dimensional (2D) display mode and a 3-dimensional (3D) display mode based on the comparison of the determined ambient light level to the ambient light threshold.

28. A computer-readable medium storing computer executable code of a user equipment (UE), comprising code to:
determine a brightness level of a display screen of the UE; and
set a resolution mode of the display screen based on the brightness level.
